(19) United States
(12) Patent Application Publication
(10) Pub. No.: US 2023/0264396 A1
(43) Pub. Date: Aug. 24, 2023

(54) METHOD FOR MANUFACTURING A PART MADE OF A HARD MATERIAL WITH A POLYMER INSERT

(71) Applicant: Comadur SA, Le Locle (CH)

(72) Inventors: Paulo AREDE, La Chaux-de-Fonds (CH); Damien CARTIER, Besancon (FR); Alexandre BRUTILLOT, Morteau (FR); Pierry VUILLE, Les Emibois (CH)

(73) Assignee: Comadur SA, Le Locle (CH)

(21) Appl. No.: 18/006,604

(22) PCT Filed: Aug. 26, 2021
(86) PCT No.: PCT/EP2021/073582

§ 371 Date: Jan. 24, 2023

(30) Foreign Application Priority Data
Sep. 4, 2020 (EP) 20194714.0

(51) Int. Cl. B29C 45/00; B29C 45/14; B29C 71/02; G04B 3/04; G04B 37/06

(52) U.S. Cl. CPC B29C 45/0055; B29C 45/0001; B29C 45/14; B29C 71/02; G04B 3/041; G04B 37/06; B29L 2031/739

(57) ABSTRACT

A method is for manufacturing an ornamental part, for example a watch, jewellery or telephone part, in particular a watch crown. The part includes, at least partially, a hard material with a Vickers hardness exceeding 1,000 HV. The method includes the following main steps: producing a precursor from a mixture of at least one powder material with a binder, producing an insert made of a polymer material, the insert having, at least partially, a negative shape of that desired for at least one portion of the part, overmoulding the precursor onto the insert made of a polymer material by injection into a mould to form a green body, and sintering the green body to form a body of the future part from the hard material.

### TECHNICAL FIELD

The invention relates to the field of manufacturing ornamental parts, in particular in watchmaking, jewellery or telephony, the part being made of a hard material. It more specifically relates to a method for manufacturing a watch part, for example a crown or a middle, with an insert made of a polymer material.

### TECHNOLOGICAL BACKGROUND

In the watchmaking or jewellery industry, various materials are used to manufacture cases or bracelets with different looks. In particular, timepieces, especially watch cases or bracelet links, are known to be manufactured using hard materials. A hard material is understood to mean a material having a Vickers hardness exceeding 1,000 HV. Examples of such hard materials include ceramic, silicon nitride, zirconium oxide, sapphire, or alumina.

In watchmaking, they are used for their mechanical properties, in particular because they are difficult to scratch. They are used, for example, to manufacture parts such as watch middles or bracelet rings.

Ornamental parts are obtained after an injection step giving the desired shape to the part, then with a sintering step to harden the material.

However, this type of injection method does not provide sufficiently precise dimensions. For example, for links or rings in bracelets, tapped holes are needed in order to be able to screw a screw or a threaded element therein. A watch middle may require a tapped hole, for example to screw in a crown. However, for middles made of a hard material, only a pressing operation can be used to assemble crowns. Holes must also be made for push-pieces, which cannot be obtained with the injection method. In particular, threads or tappings are hard to form in a hard material.

To achieve this, the middle must be machined to form a tapping. However, hard materials are difficult to machine because of the hardness thereof. For this purpose, diamond tools with a short service life are used, which are very expensive.

### SUMMARY OF THE INVENTION

Producing a part made of a hard material that requires little or no machining of the hard material, especially for ceramic materials, but that comprises functional surfaces, for example, would be advantageous.

The present invention proposes such a method. By using a hard material and an insert made of a polymer material, the method prevents the need for directly machining the hard material. This reduces the cost of manufacturing the part by preventing the need to machine the hard material as much as possible. Moreover, it allows holes to be created to the chosen dimensions, with tapping where necessary.

More specifically, the invention relates to a method for manufacturing a part, for example a watch, jewellery or telephone part, in particular a watch middle, the part comprising, at least partially, a hard material with a Vickers hardness exceeding 1,000 HV.

According to the invention, the method comprises the following main steps:
a step of producing a precursor from a mixture of at least one powder material with a binder,
a step of producing an insert made of a polymer material, the insert having, at least partially, a negative shape of that desired for at least one portion of the part,
a step of overmoulding the precursor onto the insert made of a polymer material by injection into a mould to form a green body, and
a step of sintering said green body to form a body of the future part from said hard material.

According to one specific embodiment of the invention, the method comprises a further step of removing the polymer insert in order to obtain a part with a portion having a predetermined shape, this step preceding the sintering step.

According to one specific embodiment of the invention, the method comprises a further step of assembling the part.

According to one specific embodiment of the invention, the method comprises a step of machining the green body.

According to one specific embodiment of the invention, the overmoulding step consists in overmoulding the green body onto an insert partially inserted into the green body in order to create a hole therein.

According to one specific embodiment of the invention, the overmoulding step consists in overmoulding the green body around the insert in order to create a closed cavity therein.

According to one specific embodiment of the invention, the insert includes a thread in order to create a tapping in the green body.

According to one specific embodiment of the invention, the polymer is chosen from the following list: PVB (plasticised Polyvinyl Butyral), CAB (plasticised Cellulose Acetate Butyrate), acrylic resin of the PBMA (Poly Butyl Methacrylate) type.

According to one specific embodiment of the invention, the hard material is chosen from materials such as silicon nitride, zirconium oxide, alumina, cermets, metals or composites of these metals.

The invention further relates to an ornamental part, for example a timepiece, jewellery or telephony part, in particular a watch middle, comprising a body made of a hard material with a Vickers hardness exceeding 1,000 HV, the part being provided with a closed cavity in the thickness of the body.

The invention further relates to a watch case comprising such an ornamental part, as well as a crystal and a bezel for holding the crystal on the part, and a back for closing the watch case.

### BRIEF DESCRIPTION OF THE FIGURES

The invention will be better understood with reference to the accompanying drawing, in which:

FIG. 1 is a block diagram showing the method according to the invention,

FIGS. 2a) to 2c) show sectional views of a part obtained using the method according to the invention after certain steps,

FIGS. 3a and 3b show perspective views of a watch middle provided with a tapped hole obtained using the method according to the invention,

FIG. 4 shows a sectional view of a crown mounted on a watch middle,

FIG. 5 shows a perspective view of a bracelet link obtained using the method according to the invention,

FIGS. 6a) and 6b) show a system for carrying out the method according to the invention, and

FIGS. 7a) and 7b) show sectional views of a watch case provided with a closed cavity obtained using the method according to the invention.

### DETAILED DESCRIPTION OF THE INVENTION

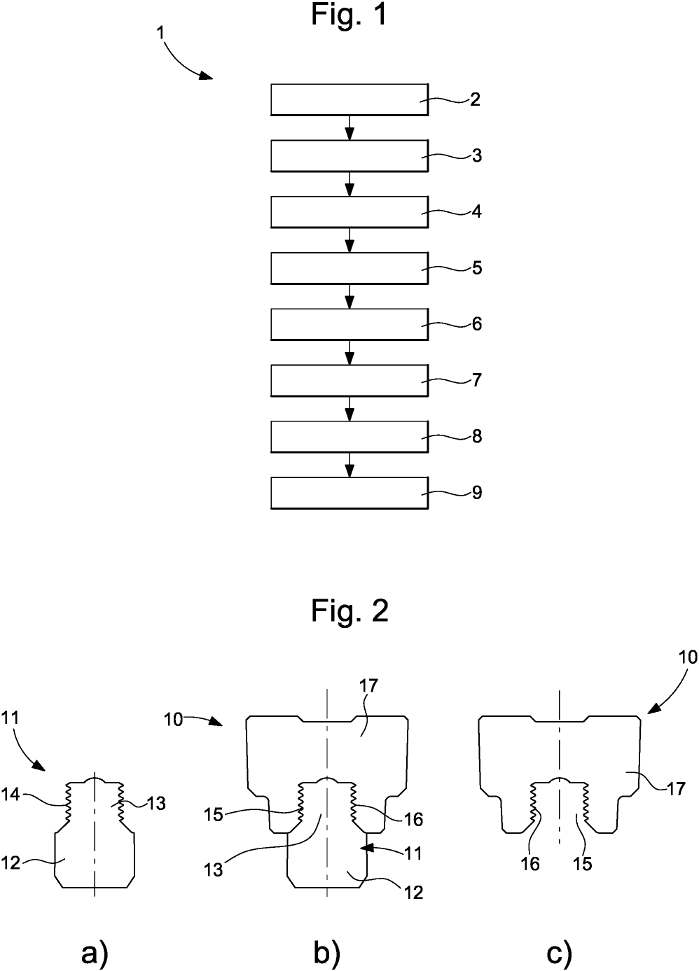

The method 1 for manufacturing an ornamental part 10, for example a timepiece, jewellery or telephony part, is shown in FIG. 1. The ornamental part is, for example, a watch case middle, a bezel, a watch case back, a stone or a push-piece of a timepiece, a jewellery bracelet or ring, or even a mobile phone case. The part 10 at least partially comprises a hard material with a Vickers hardness exceeding 1,000 HV. The hard material is, for example, a ceramic material such as an aluminium oxide (Al2O3), a zirconium oxide (ZrO2), a carbide, a nitride, a cermet, a hard metal or any other material with a Vickers hardness exceeding 1,000 HV.

The method 1 comprises a first step 2 of producing a precursor from a mixture of at least one powder material with a binder. In this context, the ceramic-based powder can contain at least a metal oxide, a metal nitride or a metal carbide. By way of example, the ceramic-based powder can contain aluminium oxide or a mixture of aluminium oxide and chromium oxide to form synthetic ruby, zirconium oxide, which can optionally be pigmented, alumina, which can optionally be pigmented, silicon nitride, cermets, metals and composites of these metals. The cermets are, for example, titanium carbide or tungsten carbide. The metals are, for example, tungsten, titanium, 316L stainless steel or steel, preferably nickel-free.

Moreover, the binder is of the organic type.

The method 1 comprises a second step 3 of producing an insert made of a polymer material, the insert having, at least partially, a negative shape of that desired for at least one portion of the part. The insert includes at least one portion having a negative shape of that desired for a portion of the final body made of the hard material. The polymer is, for example, chosen from the following list: PVB (plasticised Polyvinyl Butyral), CAB (plasticised Cellulose Acetate Butyrate), or acrylic resin of the PBMA (Poly Butyl Methacrylate) type.

A third step 4 consists in overmoulding the precursor onto the insert made of a polymer material in order to form a green body. Overmoulding is in particular carried out by injection into a mould. The mould at least partially has the shape of the desired part taking into account a shrinkage rate of the part. The precursor is injected into the mould through a tube, and then via precursor distribution circuits throughout the mould. The precursor thus takes the shape of the mould, for example a watch case middle as in the examples described herein. Alternatively, the injection can also be carried out using a circular tab or channels. The green body takes the shape of the mould and at least partially the shape of the insert onto which it is overmoulded.

In a fourth step 5, the green body is machined to remove unnecessary portions of the green body produced by the injection. For example, tubing or channels formed as a result of distribution circuits or tubes in the injection system are removed. This results in a machined green body.

In a fifth step 6, the polymer insert is removed by thermal debinding. Preferably, the green body overmoulded onto the insert is immersed in an 80° alcohol bath. The alcohol bath dissolves the polymer insert, such that the green body with the desired shape given by the insert is obtained. Alternatively, thermal debinding can be carried out to remove the polymer insert. The body overmoulded onto the insert is thus heated to a high temperature to remove the polymer. The green body is thus stripped of the polymer insert. The insert leaves a positive shape in the green body, such as a tapped hole.

The sixth step 7 aims to sinter said machined green body in order to form a body of the future part in said at least one hard material. Sintering consists in heating the precursor so that the grains of powder agglomerate. During sintering, the green body hardens by shrinking to produce a hard body with a sintering rate. Preferably, according to the invention, the sintering step can include pyrolysis. The body of the part obtained is substantially hardened by this step. Thus, the body of the part has a definitive shape.

A seventh step 8 may also be required to smooth-finish and/or polish the hard material. This improves the aesthetic appearance of the middle.

Finally, in an eighth step 9, the part is assembled with other elements, for example by screwing, thanks to the shape obtained using the method. For example, if the part is a horological watch middle provided with a tapped hole, a button or a crown is assembled with the middle.

FIGS. 2a) to 2c) show a green body 10 and an insert 11, which can be used to produce a crown after certain steps of the method. At the end of the second production step, an insert 11 with a preferred shape, such as that shown in FIG. 2a), is obtained. In this example, the insert 11 is a cylindrical element with a first section 12 and a second section 13, the second section 13 being intended to give the green body 10 an internal shape. The second section 13 is narrower than the first section 12 and includes a thread 14 on the periphery thereof. The insert 11 is used to form a cylindrical hole 15 in the green body 10, the hole 15 being provided with a tapping 16 on the inner peripheral wall of the crown. This allows the finished part to be screwed during the assembly step.

In FIG. 2b), the precursor is overmoulded onto the insert 11, resulting in an assembly as shown in FIG. 2b). In this example, a green body 10 in the shape of a watch crown has been formed on the insert 11. The crown is cylindrical and has a thicker portion 17 at one end. The green body 10 is overmoulded onto the second section 13 of the insert 11, such that the second section 13 of the insert 11 is pressed into the green body 10. Thus, when the insert 11 is removed, a hole 15 is formed in the green body 11 shown in FIG. 2c). It can also be seen that the thread 14 of the insert 11 has impressed a tapping 16 into the hole 15 of the green body 10. After the step of removing the polymer insert 11 and sintering the green body 10, a crown with a tapped hole is obtained. The crown can be screwed onto a stem of a horological movement through the middle of a watch.

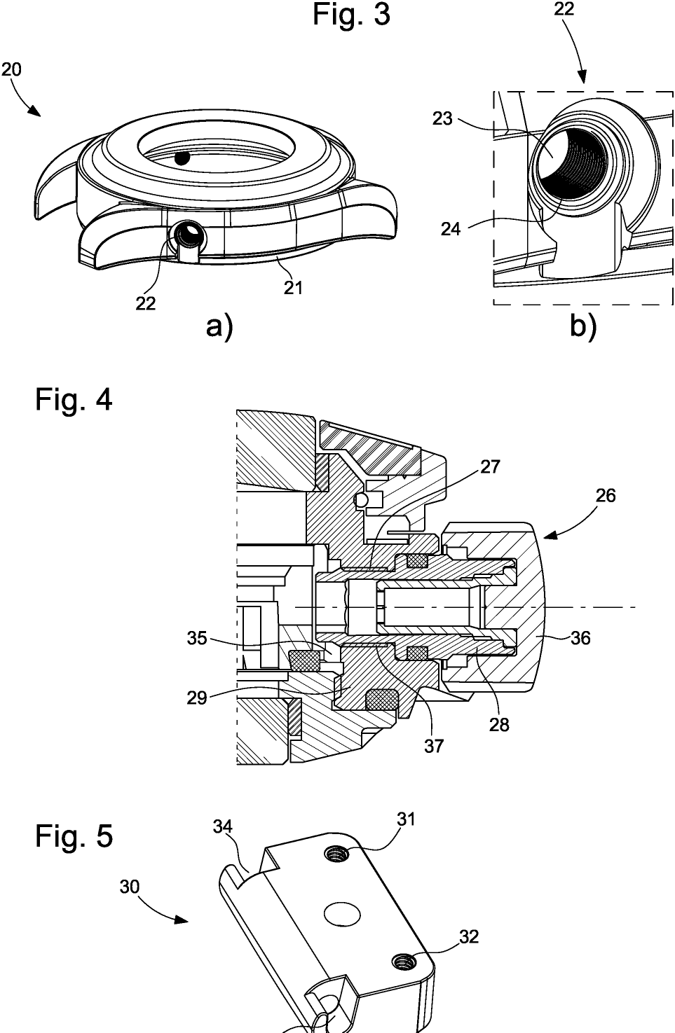

FIGS. 3a) and 3b) show another example of a part produced using this method. The part is a middle 20 provided with a tapped hole 22, which facilitates the assembly of a button for example, by screwing it into the hole. The hole 22 is arranged on the peripheral face 21 of the middle. The enlargement of the hole 22 in FIG. 3b) shows the internal tapping.

FIG. 4 shows another example of an ornamental part produced using the method according to the invention. A watch middle 29 includes a hole 35 provided with a tapping 27 for screwing in a tube 28 of a crown 26. The crown 26 comprises a tube 28 and a head 36 of the crown 26 assembled together. The tube 28 comprises a thread 37 on the peripheral wall thereof, which cooperates with the tapping 27 of the hole 35. The middle 20 with the tapped hole 35 is obtained using the method according to the invention, in particular the tapped hole 35 is formed using a polymer insert.

Another example of an ornamental part produced using the method according to the invention is a bracelet link or ring 30, shown in FIG. 5. The link 30 is substantially flat and elongate. The link comprises a longitudinal through-opening 34 to accommodate a pin for assembly with a watch middle. The link 30 includes two tapped holes 31, 32, which allow the link 30 to be screwed to another link. The holes 31, 32 are obtained using a polymer insert. The method also allows holes 31, 32 to be made close to one another.

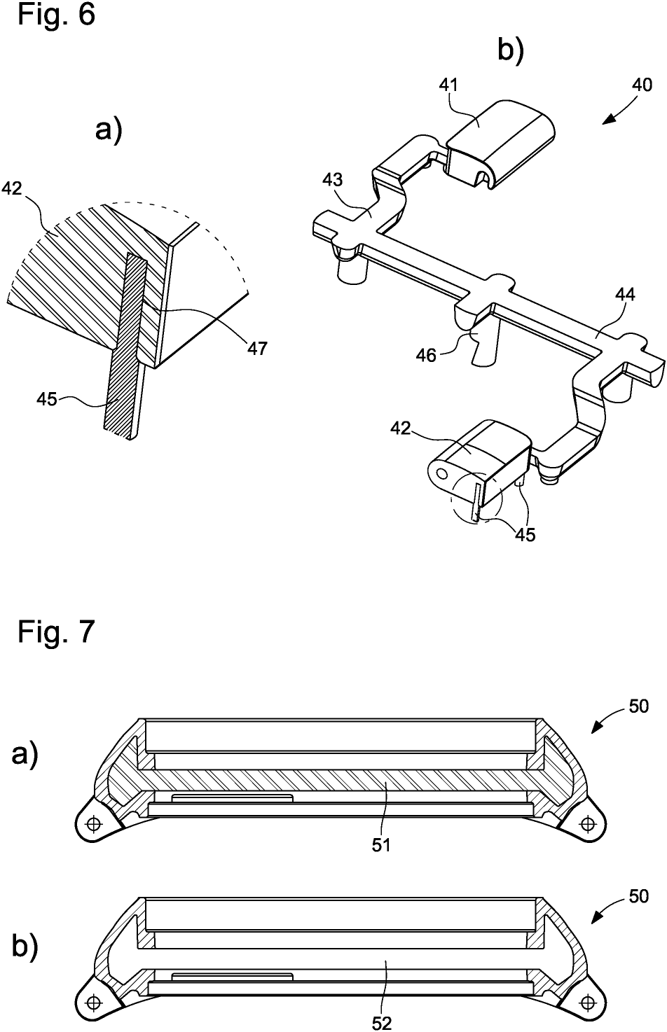

One example of a system 40 for carrying out the step of overmoulding the link 30 is shown in FIGS. 6a) and 6b). Two link-shaped moulds 41, 42 are shown, each mould 41, 42 being arranged at the end of a precursor supply duct 43, 44. A main duct 46 allows the precursor to be injected, which precursor is distributed through the two supply ducts 43, 44 to the moulds 41, 42. The moulds 41, 42 have openings through which inserts 45 can be positioned. The inserts 45, shown in a close-up view in FIG. 6a), are cylindrical in shape, and are provided at least partially with a peripheral thread 47. The threaded portion is inserted into the mould 41, 42 through an opening. A second portion that is wider than the opening remains outside the mould 41, 42. Thus, when the precursor is injected into the moulds 41, 42, the resulting green body has the shape of the link and is overmoulded onto the inserts 45 simultaneously. The link, with the one or more inserts, is then removed from the mould, and the subsequent steps are carried out, including removing the inserts 45.

The method according to the invention further allows a green body 50 to be overmoulded around an insert 51 in order to create a closed cavity 52 therein. Closed is understood to mean that the cavity is continuously surrounded by material, i.e. by the material of the body. The insert 51 is completely surrounded by the precursor. The polymer insert is then removed during the removal step in the same way as for a partially overmoulded insert. Such a method allows, for example, a lighter watch middle to be produced, since the middle is partially void of material. FIG. 7a) shows a green body 50 in the form of a watch middle, with an insert 51 encased in the material of the middle. When the insert 51 has disappeared, a void 52 appears in the thickness of the material forming the middle, as shown in FIG. 7b). Such a method makes the part lighter, and reduces the amount of material used to manufacture it.

Other parts can be produced using the method described hereinabove. For example, a bezel, a back, a stone or a push-piece of a timepiece can be made, as well as a jewellery bracelet or ring, or a telephone case. All of these parts include a body made of a hard material provided with a hole or a cavity.

1-8. (canceled)

9. A method for manufacturing an ornamental part, the part comprising, at least partially, a hard material with a Vickers hardness exceeding 1,000 HV, the method comprising:
producing a precursor from a mixture of at least one powder material with a binder;
producing an insert made of a polymer material, the insert having, at least partially, a negative shape of a shape desired for at least one portion of the part;
overmoulding the precursor onto the insert made of a polymer material by injection into a mould to form a green body, the overmoulding including overmoulding the green body around the entire insert;
removing the polymer insert to obtain a part with a closed cavity; and
sintering said green body to form a hard body of the future part from said hard material.

10. The method according to claim 9, further comprising assembling the part.

11. The method according to claim 9, further comprising machining the green body.

12. The method according to claim 9, wherein the insert includes a thread to create a tapping in the green body.

13. The method according to claim 9, wherein the polymer is chosen from the following list: PVB (plasticised Polyvinyl Butyral), CAB (plasticised Cellulose Acetate Butyrate), or acrylic resin of the PBMA (Poly Butyl Methacrylate) type.

14. The method according to claim 9, wherein the hard material is chosen from materials including as silicon nitride, zirconium oxide, alumina, cermets, metals or composites of these metals.

15. The method according to claim 9, wherein the ornamental part is a watch, jewelry a telephone part, or a watch crown.

16. An ornamental part, comprising:
a body made of a hard material with a Vickers hardness exceeding 1,000 HV, the part being provided with a closed cavity in a thickness of the body.

17. The ornamental part according to claim 16, wherein the ornamental part is a watch, jewelry a telephone part, or a watch crown.

18. A watch case, comprises:
the ornamental part according to claim 16;
a crystal;
a bezel configured to hold the crystal on the ornamental part; and
a back that closes the watch case.
